(19) United States
(12) Patent Application Publication
(10) Pub. No.: US 2024/0308024 A1
(43) Pub. Date: Sep. 19, 2024

(54) VEHICLE WAXING SYSTEM AND VEHICLE WAXING METHOD

(71) Applicant: National Taiwan University of Science and Technology, Taipei (TW)

(72) Inventor: Chyi-Yeu Lin, Taipei (TW)

(73) Assignee: National Taiwan University of Science and Technology, Taipei (TW)

(21) Appl. No.: 18/311,900

(22) Filed: May 4, 2023

(30) Foreign Application Priority Data
Mar. 15, 2023 (TW) 112109476

(51) Int. Cl. B24B 49/12; B24B 37/005; B24B 37/34; B60S 3/06

(52) U.S. Cl. CPC B24B 49/12; B24B 37/005; B24B 37/34; B60S 3/06

(57) ABSTRACT

A vehicle waxing system and a vehicle waxing method. The vehicle waxing system includes one or more waxing movement mechanisms and a controller. Each of the waxing movement mechanisms is provided with a waxing device and configured to move the waxing device of disposition to perform a waxing operation. The controller is coupled to the waxing movement mechanism. The controller is configured to determine a waxing area of a vehicle according to vehicle external outline information and waxing portion information, and determine the movement trajectory of the waxing operation performed on the waxing area by the waxing device disposed by the waxing movement mechanism. Therefore, an autonomous waxing operation may be achieved.

### CROSS-REFERENCE TO RELATED APPLICATION

This application claims the priority benefit of Taiwan application serial no. 112109476, filed on Mar. 15, 2023. The entirety of the above-mentioned patent application is hereby incorporated by reference herein and made a part of this specification.

### BACKGROUND

### Technical Field

The disclosure relates to an automatic control technology, and in particular to a vehicle waxing system and a vehicle waxing method.

### Description of Related Art

Cars are one of the means of transportation frequently used by modern people. Because of the characteristics of comfort, safety and high mobility, most families or companies own cars. Most car owners are willing to wash or groom their cars. Automatic car washing machines are also often seen on the road. However, waxing still needs to be done manually, and no system or equipment is yet available on the market that may perform fully autonomous waxing on the entire vehicle.

### SUMMARY

In view of this, embodiments of the disclosure provide a vehicle waxing system and a vehicle waxing method, which may perform a fully autonomous waxing operation on a vehicle.

The vehicle waxing system of the embodiment of the disclosure includes (but not limited to) one or more waxing movement mechanisms and a controller. Each of the waxing movement mechanisms is provided with a waxing device and configured to move the waxing device of disposition to perform a waxing operation. The controller is coupled to the waxing movement mechanism. The controller is configured to determine a waxing area of a vehicle according to vehicle external outline information and waxing portion information, and determine the movement trajectory of the waxing operation performed on the waxing area by the waxing device disposed by the waxing movement mechanism. The vehicle external outline information is related to a three-dimensional surface shape of the vehicle. The waxing portion information is related to one or more portions where waxing operations are expected to be performed on the vehicle body. The movement trajectory is related to a continuous combination of multiple postures of the waxing device with relative positions and relative orientations in the waxing area.

The vehicle waxing method according to the embodiment of the disclosure includes (but not limited to) the following steps: A waxing area of a vehicle body is determined according to vehicle external outline information and waxing portion information. The vehicle external outline information is related to a three-dimensional surface shape of the vehicle body, and the waxing portion information is related to one or more portions where waxing operations are expected to be performed on the vehicle body. A movement trajectory of the waxing operation performed on the waxing area by a waxing device disposed by a waxing movement mechanism is determined. The movement trajectory is related to a continuous combination of multiple postures of the waxing device with relative positions and relative orientations in the waxing area.

Based on the above, according to the vehicle waxing system and the vehicle waxing method of the embodiments of the disclosure, the waxing area on the three-dimensional surface shape of the vehicle is determined, and the movement trajectory of the waxing device driven by the waxing movement mechanism is planned accordingly. In this way, human intervention may be removed, and the work efficiency of vehicle body waxing can be greatly improved.

In order to make the aforementioned features and advantages of the disclosure comprehensible, embodiments accompanied with drawings are described in detail as follows.

### BRIEF DESCRIPTION OF THE DRAWINGS

FIG. 1 is a block diagram of elements of a vehicle waxing system according to an embodiment of the disclosure.

FIGS. 2A and 2B are schematic diagrams of a vehicle waxing system-a vehicle moving on a traveling track according to a first embodiment of the disclosure.

FIG. 2C is a schematic diagram of a vehicle waxing system-three sets of waxing movement mechanisms according to a second embodiment of the disclosure.

FIG. 2D is a schematic diagram of a vehicle waxing system-a movable base according to a third embodiment of the disclosure.

FIGS. 3A and 3B are schematic diagrams of a vehicle waxing system-a rotating platform according to a fourth embodiment of the disclosure.

FIG. 4 is a flow chart of a vehicle waxing method according to an embodiment of the disclosure.

FIG. 5 is a flow chart of waxing portion information determination according to an embodiment of the disclosure.

FIG. 6 is a flow chart of waxing portion information determination according to another embodiment of the disclosure.

FIG. 7 is a flow chart of waxing reinforcement determination according to an embodiment of the disclosure.

### DESCRIPTION OF THE EMBODIMENTS

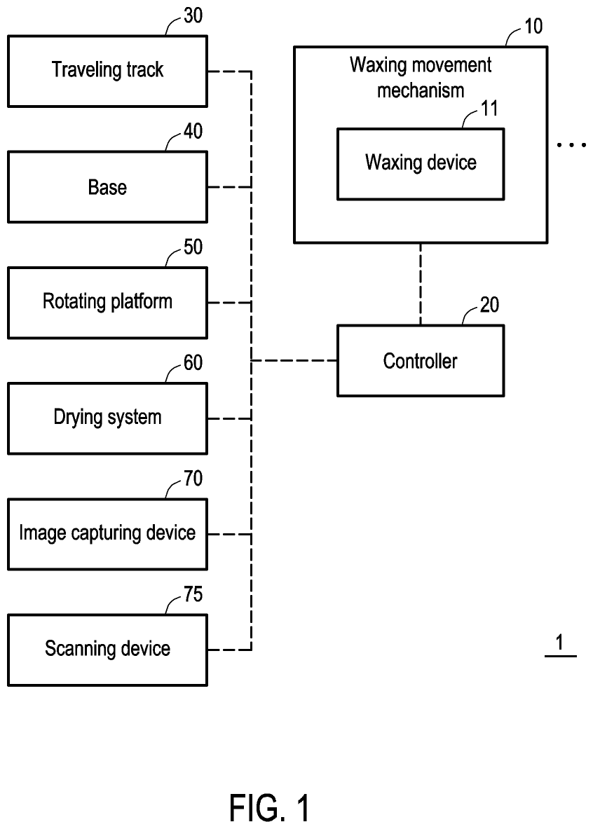

FIG. 1 is a block diagram of elements of a vehicle waxing system 1 according to an embodiment of the disclosure. Referring to FIG. 1, the vehicle waxing system 1 includes (but not limited to) one or more waxing movement mechanisms 10 and a controller 20.

The waxing movement mechanism 10 may be a multi-axis mechanical arm, a multi-degree-of-freedom mechanism, a height adjustment platform, a slide rail, a turntable, a ballscrew, a motor, or a cylinder, and other types of mechanical components that may drive connecting elements to move or rotate, or a combination thereof, so as to drive a waxing device 11 of disposition to lift, move and/or rotate.

Each of the waxing movement mechanisms 10 is provided with one or more waxing devices 11 (or referred to as waxing machines, wax applicators, polishing machines, or electric grinding tools). For example, the waxing device 11 is disposed at the end of a mechanical arm. However, the embodiment of the disclosure does not limit the connection manner between the waxing movement mechanism 10 and the waxing device 11. The waxing device 11 may include a main drive, an adapter plate and abrasive pads such as sponges, cotton sleeves or sandpaper. In an embodiment, the waxing device 11 is configured to perform a waxing operation. The waxing operation is, for example, waxing (the types of waxes may be liquid and solid), polishing or grinding. In an embodiment, the waxing device 11 may be dedicated to treating specific portions of the vehicle body. For example, the waxing device 11 is dedicated for door handles. In an embodiment, a force maintainer is further disposed between the waxing movement mechanism 10 and the waxing device 11 to maintain the magnitude of the force applied by the waxing device 11 to the vehicle body of the vehicle.

The controller 20 is wired or wirelessly coupled to the waxing movement mechanism 10. The controller 20 may also be a desktop computer, a notebook computer, a smart phone, a tablet computer, a workstation, a host computer, or a processor (for example, a central processing unit (CPU), a microcontroller, a programmable controller, an application-specific integrated circuit (ASIC), a chip, or other similar elements or a combination thereof) of these devices.

Referring to FIG. 1, in an embodiment, the vehicle waxing system 1 further includes a traveling track 30. The traveling track 30 is configured for a vehicle (for example, a car, a bus or a motorcycle) to move thereon. One of the purposes of the traveling track 30 is to keep the vehicle in a fixed position.

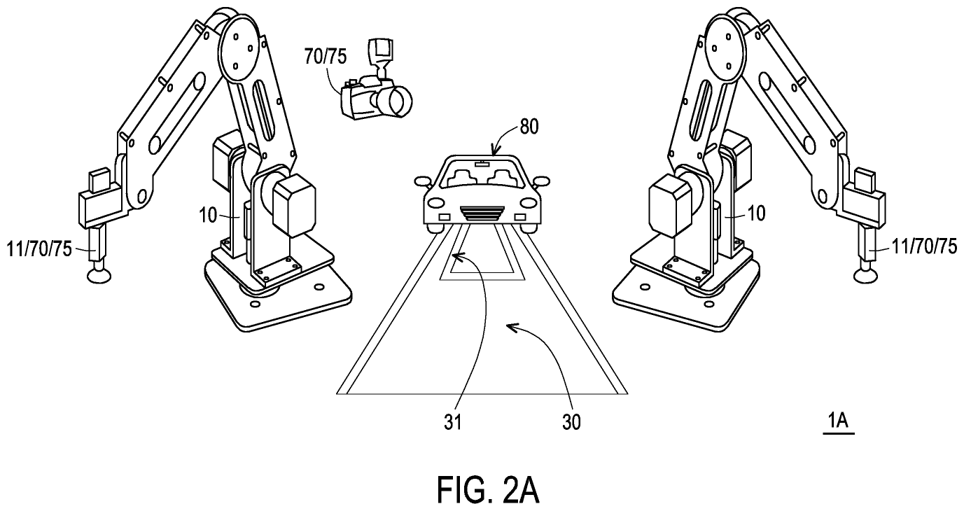

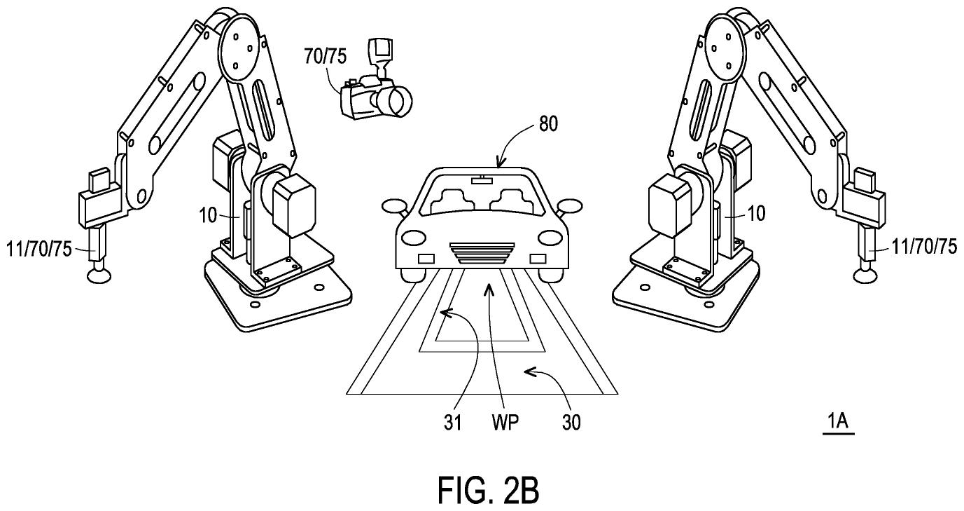

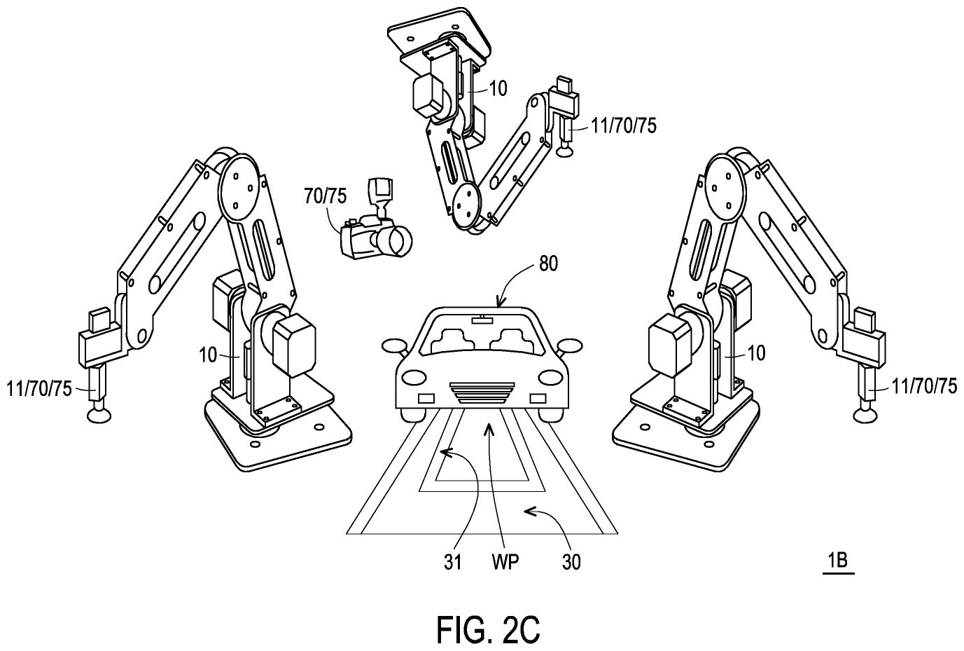

For example, FIGS. 2A and 2B are schematic diagrams of a vehicle waxing system 1A—a vehicle moving on the traveling track 30 according to a first embodiment of the disclosure. Referring to FIGS. 2A and 2B, the traveling track 30 is roughly aligned with the tires of a vehicle 80, and a moving platform 31 drives the vehicle 80 so that the vehicle 80 moves along the traveling track 30. When the vehicle 80 moves to a working position WP shown in FIG. 2B, the moving platform 31 may stop moving. In an embodiment, the controller 20 is coupled to the moving platform 31 and defines the working position WP, thereby actively controlling the position of the vehicle 80 on the traveling track 30.

In an embodiment, the waxing movement mechanism 10 is disposed on one side of, both sides of and/or above the traveling track 30. As shown in FIG. 2B, the left and right sides of the traveling track 30 are provided with the waxing movement mechanisms 10. In FIG. 2B, the dispositions of one waxing movement mechanism 10 and the waxing device 11 thereof may be omitted.

For another example, FIG. 2C is a schematic diagram of a vehicle waxing system 1B-three sets of the waxing movement mechanisms 10 according to a second embodiment of the disclosure. Referring to FIG. 2C, the left and right sides of and above the traveling track 30 are provided with the waxing movement mechanisms 10.

In other embodiments, the position of the waxing movement mechanism 10 relative to the traveling track 30 may still be changed according to actual needs.

Referring to FIG. 1, in an embodiment, the vehicle waxing system 1 further includes a base 40 movable along the traveling track 30. The base 40 may be disposed on the ground or in the air, and may be driven by other moving mechanisms to move. In addition, the waxing movement mechanism 10 may be disposed on the base 40.

FIG. 2D is a schematic diagram of a vehicle waxing system 1C—the movable base 40 according to a third embodiment of the disclosure. Referring to FIG. 2D, the base 40 in the vehicle waxing system 1C may move along the traveling track 30 (for example, in a direction D1 or D2 or the opposite direction).

In an embodiment, the controller 20 may determine the position of the base 40, thereby actively controlling the position of the waxing movement mechanism 10 relative to the vehicle 80.

Referring to FIG. 1, in an embodiment, the vehicle waxing system 1 further includes a rotating platform 50. The rotating platform 50 is coupled to the controller 20 and provided for vehicle placement. In addition, the controller 20 may drive the rotating platform 50 to rotate. In an embodiment, the waxing movement mechanism 10 is disposed on one side of, both sides of and/or above the rotating platform 50.

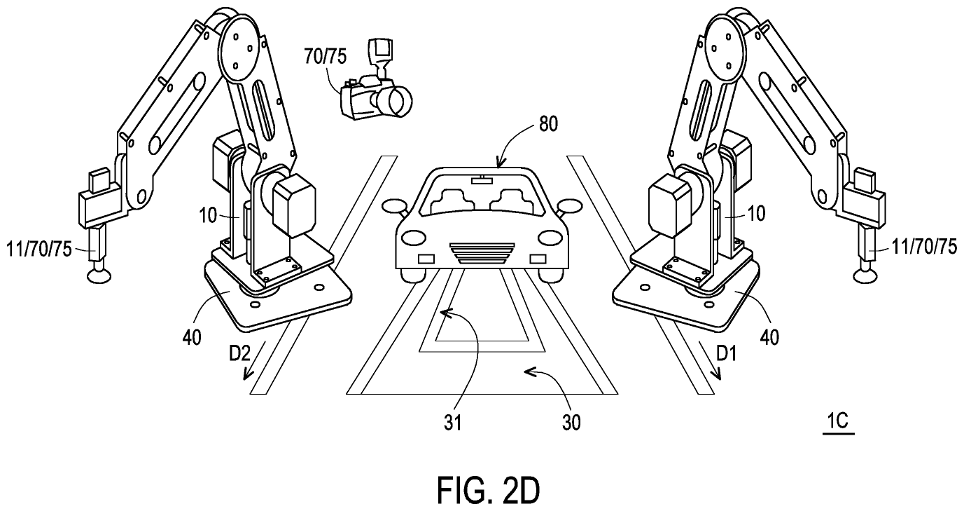

For example, FIGS. 3A and 3B are schematic diagrams of a vehicle waxing system 1D—the rotating platform 50 according to a fourth embodiment of the disclosure. Referring to FIG. 3A, when the vehicle 80 is on the rotating platform 50, the controller 20 may drive the rotating platform 50 to rotate according to requirements. Referring to FIG. 3B, merely one side of the rotating platform 50 is provided with the waxing movement mechanism 10. After the rotating platform 50 rotates 180 degrees along a direction D3, the other side of the vehicle 80 may face the waxing movement mechanism 10.

In addition, the embodiment of the waxing movement mechanisms 10 being disposed on both sides of the rotating platform 50 may refer to FIG. 2B, the embodiment of the waxing movement mechanisms 10 being disposed on both sides of and above the rotating platform 50 may refer to FIG. 2C, and the descriptions are not repeated here. However, the position of the waxing movement mechanism 10 relative to the rotating platform 50 may still be changed according to actual needs.

Referring to FIG. 1, in an embodiment, the vehicle waxing system 1 further includes a drying system 60. The drying system 60 may be a fan or a combination of an air compressor and an air gun. The drying system 60 may be disposed beside (and above) the traveling track 30 or the rotating platform 50. The drying system 60 is configured to spray gas to the vehicle body of the vehicle to dry the moisture on the vehicle body. Such a way is more suitable for performing a waxing operation on a vehicle that has just completed a car wash program in an automatic car washing machine.

In an embodiment, the vehicle waxing system 1 may further include one or more image capturing devices 70. The image capturing device 70 is coupled to the controller 20. The image capturing device 70 may be a device configured to capture images such as a camera, a video camera, etc., and the image capturing device 70 may include an image sensor (for example, a charge coupled device (CCD), a complementary metal-oxide-semiconductor (CMOS), etc.), an optical lens, an image control circuit and other elements. In the embodiment, the lens specifications of the image capturing device 70 (for example, the image aperture, magnification, focal length, image viewing angle, image sensor size, etc.) are different, and the number of the image capturing device 70 may be adjusted according to actual needs. In an embodiment, the image capturing device 70 is configured to photograph the vehicle and generate an image accordingly.

In an embodiment, the vehicle waxing system 1 may further include a scanning device 75. The scanning device 75 is coupled to the controller 20. The scanning device 75 may be an image capturing device such as a two-dimensional or three-dimensional camera, a video camera, or a structured light module, a scanner, a laser range finder, or other stereoscopic imaging or distance measuring devices. In an embodiment, the scanning device 75 is configured to perform three-dimensional scanning on the vehicle body of the vehicle to obtain geometric information (for example, the length, angle, connecting surface, shape and/or curved surface) of the surface of the vehicle body. In another embodiment, a single point, several points or a line laser range finder may be configured to perform geometric detection of a specific area on the vehicle body. In some embodiments, the geometric information is configured to create a three-dimensional model of the vehicle body (hereinafter referred to as a vehicle body model). A part of the three-dimensional vehicle body model created according to different scanning devices 75 merely contain a point cloud with position information, for example, using a structured light module to perform scanning; another part further contains color information of each point, which may be configured to determine the surface properties of an object, for example, using a three-dimensional camera to perform scanning.

Referring to FIGS. 2A to 3B, one or more image capturing devices 70 and/or scanning devices 75 may be fixed on the side of or above the traveling track 30, and perform image capturing or scanning on the car above while moving. As shown in FIGS. 2A to 2D, the image capturing device 70 and/or the scanning device 75 fixed above the traveling track 30 may photograph or scan the vehicle 80 during the travel of the vehicle 80. One or more image capturing devices 70 and/or scanning devices 75 may also be fixed on the side of or above the rotating platform 50, and perform image capturing or scanning on the car above while rotating. As shown in FIGS. 3A to 3B, the image capturing device 70 and/or the scanning device 75 fixed above the rotating platform 500 may photograph or scan the vehicle 80 during the rotation of the vehicle 80. In some embodiments, one or more waxing movement mechanisms 10 may also be provided with the image capturing device 70 and/or the scanning device 75. For example, the image capturing device 70 and/or the scanning device 75 are disposed at the end of the mechanical arm. However, the embodiment of the disclosure does not limit the connection manner between the waxing movement mechanism 10 and the image capturing device 70 and/or the scanning device 75.

Hereinafter, the method described in the embodiment of the disclosure is to be described with various devices and elements in the vehicle waxing system 1. Each process of the method may be adjusted accordingly according to the implementation situation, and is not limited thereto.

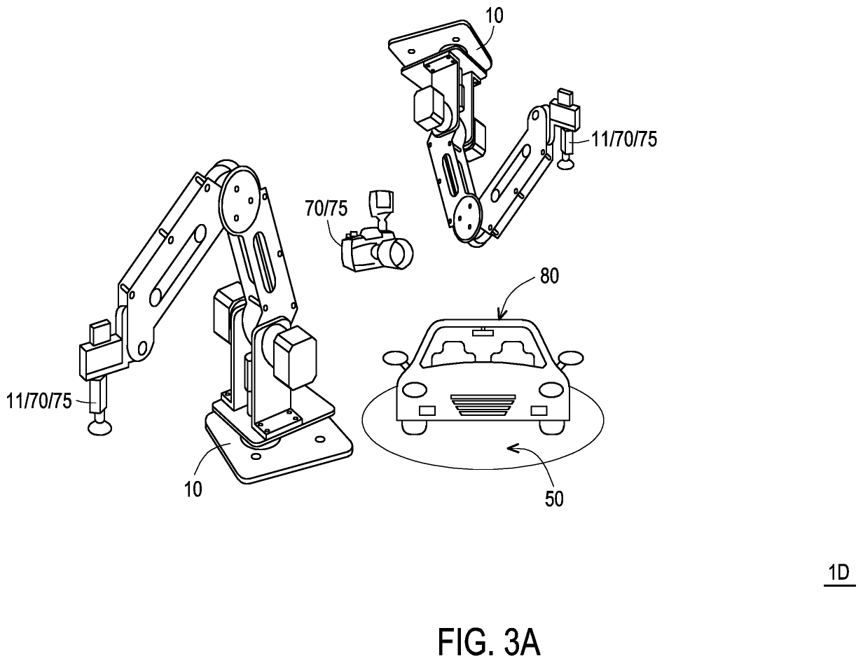

FIG. 4 is a flow chart of a vehicle waxing method according to an embodiment of the disclosure. Referring to FIG. 4, the controller 20 determines a waxing area of the vehicle body of the vehicle according to the vehicle external outline information and the waxing portion information (step S410). Specifically, the vehicle external outline information is related to the three-dimensional surface shape of the vehicle body. The surface shape may be related to the shape, size and curvature of various areas of small area on the surface or curved surface of the vehicle body.

In an embodiment, the scanning device 75 may scan the vehicle body to obtain the vehicle external outline information. In an embodiment, the scanning device 75 may surround the vehicle body to scan the appearance of all sheet metal, glass and decorative panels. In another embodiment, the scanning device 75 may merely perform scanning on a specific portion of the vehicle body (for example, the sheet metal, hood or door) according to instructions. The controller 20 may establish the vehicle external outline information based on the scanning results (for example, images, position information, etc.) of the scanning device 75. The vehicle external outline information may be in the form of a point cloud or other three-dimensional models.

In an embodiment, the controller 20 may access the vehicle external outline information from a file system. The storage space of the file system may be provided by a built-in memory, a storage carrier, or a network disk. The vehicle external outline information of one or more vehicle types has been stored in the file system in advance and may be accessed by the controller 20. For example, a car factory or someone else voluntarily scans the vehicle body and provides a model file (recording the vehicle external outline information) for other users to download or use.

In another aspect, the waxing portion information is related to one or more portions (for example, the door, hood, or all or specified sheet metal) where the waxing operation is expected to be performed on the vehicle body of the vehicle.

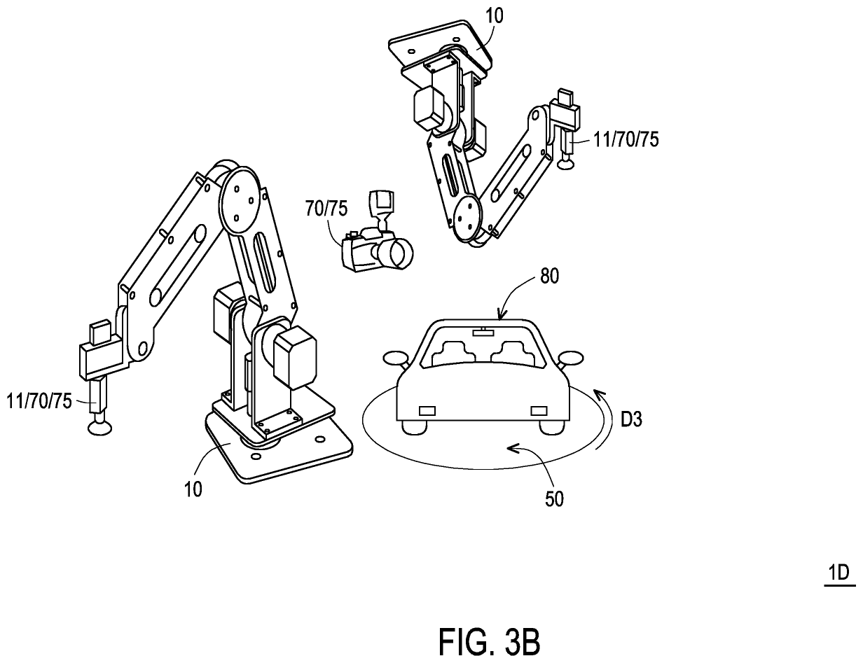

FIG. 5 is a flow chart of waxing portion information determination according to an embodiment of the disclosure. Referring to FIG. 5, the controller 20 may identify a portion of a vehicle according to an image obtained by the image capturing device 70 (step S510). Specifically, according to different design requirements, the portion of the vehicle may be defined as a sheet metal part and a non-sheet metal part (for example, glass or plastic); a painted part (for example, the door, roof, hood, or bumper) and an unpainted part (for example, the window, rearview mirror, or exhaust pipe); and parts such as the door, bumper, bodywork, and hood. In an embodiment, if the scanning device 75 may obtain not only the external outline information of the vehicle body, but also the color information of the external outline at the same time, the portion of the vehicle identified based on the image obtained by the image capturing device 70 may be replaced (step S510). The identification of the portion may be based on an object detection technology. For example, the controller 20 may apply an algorithm based on a neural network (for example YOLO (You only look once)), a region based convolutional neural network (R-CNN), or a fast R-CNN (Fast CNN) or an algorithm based on feature matching (for example, feature comparison of Histogram of Oriented Gradient (HOG), scale-invariant feature transform (SIFT), Harr, or Speeded Up Robust Features (SURF)), or a computer vision algorithm based on surface color information to achieve object detection. The controller 20 may determine whether the object in the image is a preset portion.

The controller 20 may determine the waxing portion information according to the identification result of the portion (step S520). Specifically, portions such as windshields, windows, rearview mirrors, lights, radiator guards, etc. are not suitable or required for waxing. In general, the waxing operation is usually performed on the painted part (for example, the door, roof, hood, or bumper). The controller 20 may pre-define or designate based on a user's selection the portions of the vehicle body that need to be waxed, determine whether the identification result matches the defined or selected portions, and generate the waxing portion information of the current vehicle accordingly.

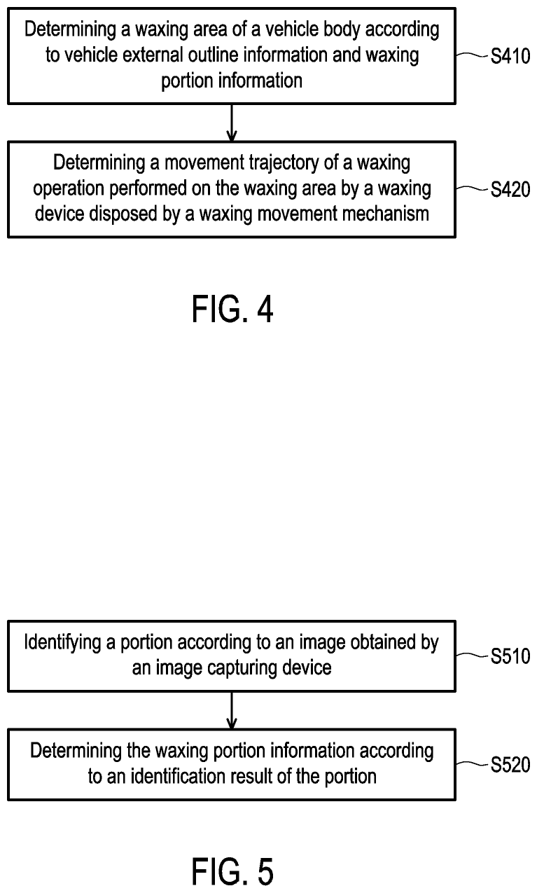

FIG. 6 is a flow chart of waxing portion information determination according to another embodiment of the disclosure. Referring to FIG. 6, the controller 20 may determine an excluded portion of the vehicle body according to the vehicle external outline information or the image obtained by the image capturing device 70 or the scanning device 75 (step S610). For example, the vehicle external outline information is a vehicle model (the portion corresponding to each area has been defined), and the controller 20 may determine the portion on the vehicle body that does not need to be waxed according to the vehicle model to serve as the excluded portion. For another example, the controller 20 identifies the portion on the vehicle body in the image that does not need to be waxed based on the object detection technology to serve as the excluded portion.

Next, the controller 20 may determine the waxing portion information according to the excluded portion (step S620). Specifically, the controller 20 may delete the excluded portion from all the portions of the vehicle, and determine the waxing portion information according to the remaining portions that have not been deleted. For example, if the excluded portions are windows and radiator grilles, the remaining portions may be roof, doors, hood, fenders, etc.

After determining the waxing portion information and the vehicle external outline information, the controller 20 may determine the position of the portion to be waxed on the three-dimensional surface of the vehicle body model, and accordingly determine the waxing area. That is to say, the waxing area is the portion to be waxed determined by the waxing portion information and has the three-dimensional surface shape defined by the vehicle outline information.

Referring to FIG. 4, the controller 20 determines the movement trajectory of the waxing operation performed on the waxing area by the waxing device 11 disposed by the waxing movement mechanism 10 (step S420). Specifically, the movement trajectory is related to the continuous combination of multiple postures of the waxing device 11 with relative positions and relative orientations in the waxing area. That is, the position and the orientation where the waxing device 11 stays after driven by the waxing movement mechanism 10 may correspond to the waxing trajectory where the waxing device 11 touches the vehicle body. For example, a three-dimensional space has six degrees of freedom, three of which are related to relative positions, and the remaining three are related to relative angles or orientations. The staying position and orientation and the moving direction of the waxing device 11 during the movement may serve as the content of the movement trajectory. Each staying position in the trajectory and the corresponding orientation and moving direction of the waxing device 11 may be combined into the continuous combination according to the moving sequence of the waxing device 11.

In an embodiment, the controller 20 may plan the movement trajectory of the waxing movement mechanism 10 according to the spatial relationship between the waxing device 11 and the waxing area of the vehicle body. The spatial relationship is, for example, the position and the orientation in a three-dimensional space. Based on the spatial relationship, the controller 20 may plan the waxing device 11 to move to a specific position with a specific posture, or the controller 20 may deduce how the moving platform 31, the rotating platform 50 or the base 40 moves based on formulas, look-up tables or artificial intelligence (AI), so that the waxing device 11 may move to a specific position and orientation on the waxing area and perform the waxing operation on the waxing area.

Next, the controller 20 may control the multi-axis or specific axial movement of the waxing movement mechanism 10 according to the movement trajectory and the waxing trajectory, and drive the waxing device 11 to perform the waxing operation.

In an embodiment, the controller 20 may obtain a vehicle body model corresponding to the vehicle body according to the vehicle external outline information. For example, the file system stores vehicle body models of multiple vehicle models, and the controller 20 accesses a vehicle body model corresponding to the scanning result of the scanning device 75 from the file system. The controller 20 may obtain a reference trajectory corresponding to the vehicle body model. The reference trajectory is the movement trajectory of the waxing device 11 disposed by the waxing movement mechanism 10 established in advance for the vehicle body model. The reference trajectory may be a previously planned or recorded movement trajectory for the same vehicle model. The controller 20 may determine the movement trajectory of the current vehicle according to the reference trajectory. For example, the controller 20 directly uses the reference trajectory; or the controller 20 adjusts the reference trajectory according to the waxing area, and accordingly generates a new movement trajectory.

In an embodiment, the controller 20 may further adjust the position of the base 40 and/or the rotation angle of the rotating platform 50 disposed by the waxing movement mechanism 10 according to the movement trajectory, and accordingly move the base 40 or rotate the rotating platform 50. As shown in FIG. 2D, the base 40 moves in the direction D1 so that the waxing device 11 may operate on the rear door. In addition, as shown in FIGS. 3A and 3B, the rotating platform 50 rotates in the counterclockwise direction D3 so that the waxing device 11 located on one side of the rotating platform 50 may operate on the other side of the bodywork of the vehicle 80.

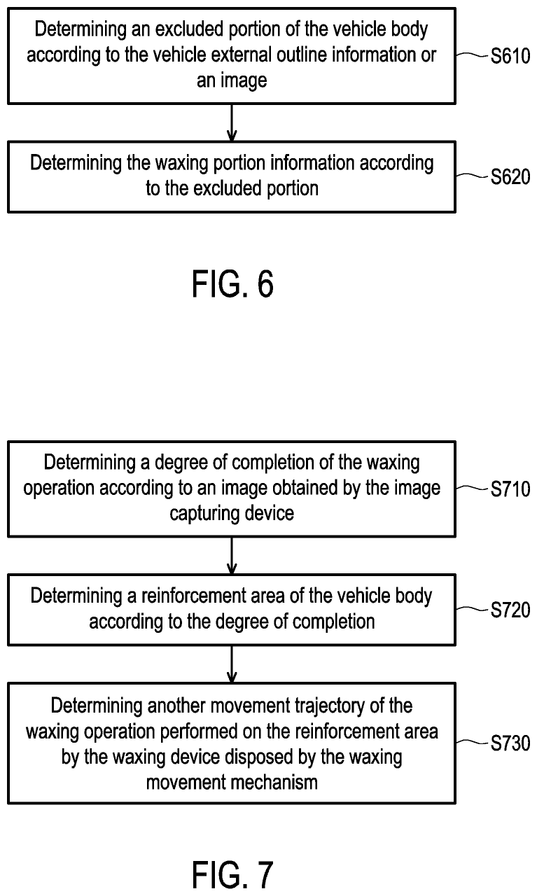

FIG. 7 is a flow chart of waxing reinforcement determination according to an embodiment of the disclosure. Referring to FIG. 7, the controller 20 may determine a degree of completion of the waxing operation according to an image captured by the image capturing device 70 (step S710). The degree of completion may be glossiness, brightness and/or chroma. For example, the controller 20 may capture the glossiness, brightness and/or chroma of various portions of the vehicle in the image.

The controller 20 may determine a reinforcement area of the vehicle body according to the degree of completion (step S720). For example, in the case of a sufficient light source, the controller 20 may divide the vehicle in the image into areas, and determine whether the brightness of each of the areas in the image reaches a corresponding threshold value. If the brightness of a certain area does not reach the threshold value, the controller 20 may determine the area as the reinforcement area. If the brightness of another area does not reach the threshold value, the controller 20 may determine that the area is not the reinforcement area. The same or similar threshold value comparison method may be used for glossiness and chroma, and the descriptions are not repeated here.

Next, the controller 20 may determine another movement trajectory of the waxing operation performed on the reinforcement area by the waxing device 11 disposed by one or more waxing movement mechanisms 10 (step S730). Referring to step S720, at this time, the waxing area is limited to the reinforcement area, and the movement trajectory for the reinforcement area may be determined. Next, the processes shown in FIG. 7 may be repeated until no reinforcement area exists, and the descriptions are not repeated here.

In an embodiment, before the waxing operation starts, the controller 20 may drive the drying system 60 so that the drying system 60 may spray gas to the vehicle to dry the moisture on the vehicle, so as to improve the accuracy of scanning performed on the vehicle body of the vehicle. Moreover, the waxing effect of the vehicle may also be increased.

To sum up, in the vehicle waxing system and the vehicle waxing method of the embodiments of the disclosure, the three-dimensional surface shape of the vehicle body and the waxing portion information are detected or obtained, and the movement trajectory of the waxing operation is determined accordingly, thereby autonomously performing the waxing operation on the vehicle body of the vehicle.

Although the disclosure has been described with reference to the above embodiments, the described embodiments are not intended to limit the disclosure. People of ordinary skill in the art may make some changes and modifications without departing from the spirit and the scope of the disclosure. Thus, the scope of the disclosure shall be subject to those defined by the attached claims.

What is claimed is:

1. A vehicle waxing system, comprising:
at least one waxing movement mechanism, wherein each of the waxing movement mechanisms is provided with a waxing device, and configured to move the waxing device of disposition to perform a waxing operation; and
a controller, coupled to the at least one waxing movement mechanism, and configured to:
determine a waxing area of a vehicle body according to vehicle external outline information and waxing portion information, wherein the vehicle external outline information is related to a three-dimensional surface shape of the vehicle body, and the waxing portion information is related to at least one portion where the waxing operation is expected to be performed on the vehicle body; and
determine a movement trajectory of the waxing operation performed on the waxing area by the waxing device disposed by the at least one waxing movement mechanism, wherein the movement trajectory is related to a continuous combination of a plurality of postures of the waxing device with relative positions and relative orientations in the waxing area.

2. The vehicle waxing system according to claim 1, further comprising:
an image capturing device, coupled to the controller, and configured to photograph the vehicle body, wherein the controller is further configured to:
identify the at least one portion according to an image obtained by the image capturing device; and
determine the waxing portion information according to an identification result of the at least one portion.

3. The vehicle waxing system according to claim 1, wherein the controller is further configured to:
determine an excluded portion of the vehicle body according to the vehicle external outline information or an image; and
determine the waxing portion information according to the excluded portion.

4. The vehicle waxing system according to claim 1, further comprising:
a scanning device, coupled to the controller, and configured to scan the vehicle body to obtain the vehicle external outline information.

5. The vehicle waxing system according to claim 1, wherein the controller is further configured to:
obtain a vehicle body model corresponding to the vehicle body according to the vehicle external outline information;
obtain a reference trajectory corresponding to the vehicle body model; and
determine the movement trajectory according to the reference trajectory.

6. The vehicle waxing system according to claim 1, further comprising:
a traveling track, provided for the vehicle to move thereon, and the at least one waxing movement mechanism being disposed on at least one of one side of, both sides of or above the traveling track.

7. The vehicle waxing system according to claim 6, further comprising:
at least one base, movable along the traveling track, wherein the at least one waxing movement mechanism is disposed on the at least one base.

8. The vehicle waxing system according to claim 1, further comprising:
a rotating platform, coupled to the controller, and provided for placement of the vehicle, wherein the controller is further configured to:
rotate the rotating platform according to the movement trajectory.

9. The vehicle waxing system according to claim 8, wherein the at least one waxing movement mechanism is disposed on at least one of one side of, two sides of or above the rotating platform.

10. The vehicle waxing system according to claim 1, further comprising:
an image capturing device, coupled to the controller, and configured to photograph the vehicle body, wherein the controller is further configured to:
determine a degree of completion of the waxing operation according to an image obtained by the image capturing device;
determine a reinforcement area of the vehicle body according to the degree of completion; and
determine another movement trajectory of the waxing operation performed on the reinforcement area by the waxing device disposed by the at least one waxing movement mechanism.

11. The vehicle waxing system according to claim 1, further comprising:
a drying system, configured to spray gas to dry the vehicle body.

12. A vehicle waxing method, comprising:
determining a waxing area of a vehicle body according to vehicle external outline information and waxing portion information, wherein the vehicle external outline information is related to a three-dimensional surface shape of the vehicle body, and the waxing portion information is related to at least one portion where a waxing operation is expected to be performed on the vehicle body; and
determining a movement trajectory of the waxing operation performed on the waxing area by a waxing device disposed by a waxing movement mechanism, wherein the movement trajectory is related to a continuous combination of a plurality of postures of the waxing device with relative positions and relative orientations in the waxing area.
